(19) United States
(12) Patent Application Publication
(10) Pub. No.: US 2016/0019487 A1
(43) Pub. Date: Jan. 21, 2016

(54) METHOD FOR STOCK-KEEPING AND/OR THE ESTIMATION OF OBSOLESCENCE RISK

(71) Applicant: Johnson Controls GMBH, Burscheid (DE)

(72) Inventor: Jelle Van Der Haak, Graz (AT)

(21) Appl. No.: 14/430,687

(22) PCT Filed: Sep. 23, 2013
(86) PCT No.: PCT/EP2013/069726

§ 371 Date: Mar. 24, 2015

(30) Foreign Application Priority Data
Sep. 25, 2012 (EP) 12006699.8

(51) Int. Cl. G06Q 10/06; G06Q 10/08

(52) U.S. Cl. CPC G06Q 10/06315; G06Q 10/087; G06Q 10/0635

(57) ABSTRACT

A method for stock-keeping and/or estimation of obsolescence risk for at least one product manufactured from at least two components, comprising the provision of a first computer means connected to at least one first database; at least one second computer means connected to at least one second database; wherein the second database is connected to the first computer means and each second computer means is connected to the first database, wherein the first and/or second databases have data about current inventory and production planning of the product and/or components thereof; and each first computer means identifies all components of the product and associated databases; each first computer means ascertains current inventory and production planning and compares current inventory and production planning with the inventory on at least one key date for the product; and each first computer means ascertains obsolescence costs and/or demands for payment for the product and/or components.

The present invention relates to a method for stock-keeping and/or the estimation of obsolescence risk for at least one product and the components thereof, wherein the product is manufactured from at least two components.

Supply chains in which components and/or products are produced on the basis of division of labor are known in industry. In the event of production migrations, for example in the ease of migrations to a new product version and/or series, or in the case of temporary suspension of production, for example owing to low demand or as a result of an economic crisis, significant costs often arise. These are caused by inventories that are still existent for old products and/or components of these products, inter alia, and are called obsolescence costs. These are a substantial economic disadvantage. A further problem is that companies or production installations in long supply chains require very long periods in order to react to order changes. These lead times make estimation of an obsolescence risk much more difficult. In addition, a production migration as a result of products and/or components that have become obsolete is often followed by claims from the respective suppliers, what are known as “obsolescence claims”. In this connection, there are often discussions within the supply chain about acceptance of these claims and/or costs.

It is an object of the present invention to eliminate the disadvantages of the prior art.

The object is achieved by a method for stock-keeping and/or the estimation of obsolescence risk for at least one product, wherein, the product is manufactured from, at least two components, comprising the provision of:
a first computer means that is connected to at least one first database by means of a data connection and
at least one second computer means that is connected to at least one second database by means of a data connection; wherein the second database is connected to the first computer means by means of a data connection and each second computer means is connected to the first database by means of a data connection, wherein the first and/or second databases have data about the current inventory of the product and/or the components thereof and the production planning therefor,

and at least the following steps:
each first computer means identifies all components of the product and preferably also the associated databases;
each first computer means ascertains the current inventory of the product and/or the components thereof;
each first computer means ascertains the production planning (for the product and/or the components thereof;
each first computer means compares the current inventory and the production planning with the inventory on at least one key date for the product, wherein the key date is present in or delivered by the database and/or another system component connected to the computer means;
each first computer means ascertains the obsolescence costs for the product and/or the components thereof.

Preferably, the method is carried out by a computer means within a supply chain. Preferably, the supply chain has at least one level, particularly an original equipment manufacturer (OEM). Particularly preferably, the supply chain has a plurality of levels, for example two, three, four, five or six levels. In this case, a first level corresponds to such production installations as produce the product, for example. A second level corresponds to production installations that produce the components of the product, for example. A third level then corresponds to such production installations as produce subcomponents, i.e. components of the components, for example.

A person skilled in the art will, understand that a production installation can foe associated with a plurality of levels simultaneously, e.g. if it produces both the product and at least one component.

In this case, a computer means is at least one numerate unit, consisting of at least one CPU and possibly a data memory. The databases may themselves in. turn foe data memories and be located in a housing with the computer means, but also accommodated separately therefrom. Said data memories may be volatile and/or nonvolatile data memories.

Preferably, a plurality of first and/or a plurality of second computer means are provided.

The data connections can foe made by wired connection, preferably via a local area network (LAN), particularly preferably by an Intranet, quite particularly preferably via a wide area network (WAN) or else preferably via a global area network (GAN), particularly via the Internet.

Additionally or alternatively, all or some of the data connections can also foe made via a wireless connection, preferably via a wireless local area network (WLAN, in line with a standard based on IEEE-802.11), particularly preferably via Bluetooth (IEEE 802.15.1).

The data connections can foe made in unencrypted form, but preferably all data connections are made in encrypted form,

According to the invention, the method comprises at least the steps explained below; first of all, a first computer means sends a command to one and/or all database(s) via the data connections in order to identify all components of the product to be produced and preferably also the databases of the production installations in which said components ate produced. By way of example, this can be accomplished by virtue of the computer means searching the inventory lists and/or materials lists for the one or more products and preferably using the data stored therein to identify the components associated with a product, and particularly preferably the databases of the associated production installations. These stored data are preferably supply agreements (scheduling agreements), but may also be other keys used within the supply chain.

Particularly preferably, components also mean subcomponents. Preferably, inventory lists and/or materials lists also mean materials stocklists.

In the next step, the computer means ascertains the current inventory of the product and/or the components thereof. In this case, “current” means at the time t₀ at which the method according to the invention is performed. To this end, it searches the databases, particularly the inventory lists and/or materials lists, of the relevant production installations for the inventories of the products and/or components produced therein.

In this case, depot in the sense of the inventory includes both static and mobile depots. In particular, at a particular time an inventory also involves those quantities of the product and/or of the components that are transported from one production installation to another production installation within the supply chain at this time. Preferably, the mobile depots also comprise stock transfers that are made in the course of stock transfer orders between production installations within the supply chain, for example, particularly for production installations of one manufacturer.

Next, or in parallel therewith or prior thereto, the computer means ascertains the production planning for the product and/or the components thereof. This is accomplished again by searching the databases for the production planning data of the relevant production installations. By way of example, the completer means thus establishes that a contract for the supply of a particular number of one or more components between one or more of the production installations for a product and/or the components thereof fails due at a particular time.

In the next step, the computer means ascertains the inventory on a key date tₓ. To this end, the computer means combines the current inventory of the product and/or the components thereof with the inventory arising from the production planning on the key date.

Preferably, the production planning comprises at least one supply agreement, particularly a quantity of the product and/or at least one of the components thereof that is to be supplied at a time t_{L}.

Preferably, empirical values are used instead of supply agreements with key dates t_{L}, in particular average supply quantities for a particular period or a period to be determined in the past and/or parameters for current supply agreements.

Preferably, the production planning comprises, in relation to the key date tₓ, the cumulated order quantities and/or times for the supply agreements at the at least one time t_{L}.

In this case, supply agreements are preferably both supply agreements with other production installations and supply agreements with customers, that is to say particularly orders. The supply agreements comprise at least a quantity for a product to be supplied, the designation thereof, for example an identification number for identification in the inventory list and/or materials list, and a key date t_{L}, particularly a due date.

Preferably, the supply agreements also comprise stock transfer orders that involve a component being transported between two production installations, for example.

In this case, the key date tₓ is present in the database connected to the first computer means, or in a different database, directly or indirectly linked to the first computer means, or in another system component that is directly or indirectly connected to the first computer means.

Finally, the computer means ascertains the obsolescence costs in the event of production stoppage or suspension for the product and/or the components thereof.

Preferably, it does so by using the current costs of the product and the components thereof, and particularly preferably the costs that can be expected on the key date are used. Also preferably, the computer means uses different costs, particularly ones that can be expected, for the different production installations.

Preferably, the computer means uses unit costs to ascertain the obsolescence costs, in. particular different unit costs for different production installations and/or current unit costs and/or average unit costs.

Quite particularly preferably, the computer means optimizes the time of production stoppage or suspension, particularly by minimising the obsolescence costs.

According to one advantageous embodiment of the method according to the invention, the computer means ascertains the possible demands for payment (obsolescence claims) for each production installation within the supply chain after the key date tₓ. Preferably, the computer means ascertains the actual demands for payment on the basis of the actual inventories if the key data tₓ is in the past. Particularly preferably, the computer means ascertains the obsolescence costs and/or demands for payment in the event of a change in the order, particularly in the event of a lower order quantity.

It is clear to a person skilled in the art that the roles of the computer means can be interchanged, so that each computer means in the supply chain can carry out the method according to the invention.

In addition, the steps for determining the respective inventories at the time t₀ and t_{L} and/or tₓ can take place either simultaneously or in any order.

Particularly preferably, the computer means can also ascertain the excess inventory of the product and/or the components thereof, that is to say the number of days and/or other time periods for which the inventory in question is still sufficient before the depot is empty. Quite particularly preferably, the excess inventory is determined in relation to the order on the key date tₓ. In this case, the excess inventory essentially corresponds to the quotient of the current inventory and the total quantity of the order, with the quantity of the order also being multiplied by a factor, said factor corresponding to the period of the order. Hence, the denominator of the excess inventory corresponds to the consumption, based on a particular period of time.

According to a further advantageous embodiment, the excess inventory can also foe specified on the basis of any period other than for the order with the key date tₓ.

According to yet a further advantageous embodiment of the method according to the invention, the computer means also computes the cumulative quantities of the product and/or the components thereof, particularly both the actual cumulative quantities and the target cumulative quantities, which essentially correspond, to the quantities produced (actual cumulative quantities) and the quantities to be supplied (target cumulative quantities), respectively. Particularly preferably, the computer means uses the cumulative quantities in order to determine the consequences of an order change and/or, following a change of model and/or production suspension and/or a break in production, the demands for payment.

Quits particularly preferably, one and/or more computer means has/have at least one input means and/or at least one display apparatus connected to it/them, so that all and/or some of the method steps and/or the result can be displayed and/or external method parameters, such as an order, a supply agreement and/or key dates, for example, can be input.

A display apparatus is preferably a printer, particularly preferably a screen, but may also be another display means with which a person skilled in the art is familiar.

Preferably, some and/or a plurality of or all data that have been described in one of the described methods or the advantageous embodiments thereof are stored. This storage is performed by the first and/or second computer means and, quite particularly preferably, will be effected in one and/or more arbitrary databases. In particular, the computer means store the data in the databases that are directly connected to them, which relate to the connected production installation directly.

According to one advantageous embodiment, the executing computer means outputs an error message via at least one connected display apparatus in the event of an error in the method. Additionally or alternatively, the executing computer means prompts the method to foe restarted and/or parameters to be input.

Preferably, prior to performance of the method, the computer means performs a system test. Particularly preferably, the computer: means performs a system test in each method step. By way of example, the system test comprises a test for whether data that are input and/or used are correct and/or admissible, whether negative quantities and/or costs arise and/or whether a predetermined value for at least one of the parameters is exceeded.

It is also conceivable for the language used in the method and/or the units used in the method to he stipulated before the method begins. It is thus preferably possible for the method to be used by product and/or component manufacturers in a. supply chain in different countries. Preferably, the unit used may be a desired currency. Particularly preferably, physical units can be displayed using the metrics system or using the Anglo-American system, for example.

According to a further advantageous form of the method, the computer means check(s), prior to access to a database and/or a computer means, whether access authorization is available. Preferably, it terminates the method if there is no or insufficient access authorization available. Particularly preferably, it then outputs an error message. Quite particularly preferably, this and/or different steps and/or elements in the method require(s) different authorizations, however.

Preferably, the method according to the invention is limited to one, two, three, four, five, six or more levels of at least one supply chain.

It would thus be conceivable for just the computer means of the end product manufacturer, or the OEM (original equipment manufacturer), to be able to be provided with a complete estimation of obsolescence risk for the entire supply chain, whereas other installations have only limited access to all data.

Preferably, the first computer means and/or the second computer means has access to all databases of all installations in a supply chain, but particularly preferably the access is configured such that a user has access only to the end result of the method, that is to say particularly is unable to view all data, such as inventories and/or excess inventories and/or supply agreements.

Preferably, at least the first computer means has at least access to the inventory lists and/or materials lists for at least one portion of the supply chain, particularly preferably the whole supply chain, and/or to the inventories for at least one portion of the supply chain, quite particularly preferably the whole supply chain, and/or the order quantity.

Particularly if a manufacturer provides a complete supply chain, that is to say all of the production installations in said supply chain, the first computer means has access to all databases of the supply chain, and/or all computer means in the supply chain have access to all databases of the supply chain, in order to carry out the method according to the invention.

Preferably, a computer means that is associated with one production installation in the supply chain, wherein the production installation is associated with a different manufacturer than the manufacturer providing the plurality of production installations forming the supply chain, has restricted access. By way of example, restricted access is intended to be understood to mean that the computer means cannot access all databases and/or all data in all databases and/or that a user cannot view all data in all databases.

Data means particularly order quantities, inventories and/or obsolescence risks and/or obsolescence costs.

In particular, the inventories are specified using excess inventories and/or are stored in the databases in the form of excess inventories.

Preferably, empirical values for supply quantities are used instead of order quantities and/or supply agreements. This advantageously allows the method according to the invention to be used both for risk assessment and for ascertainment of the actual obsolescence costs.

Preferably, the first computer means ascertains the production planning on a period-related basis. In this case, a period is a week, a day, a month, a quarter, half a year or a year, for example.

Particularly preferably, the first computer means ascertains the production planning at at least one first and at least one further time.

Preferably, the production planning comprises at least one highest possible order quantity and/or an order quantity that can be expected.

Preferably, the first computer means compares actually accrued obsolescence costs and/or demands for payment with the production planning, particularly with highest possible order quantities and/or highest possible obsolescence costs and/or highest possible demands for payment. Particularly preferably, the first computer means ascertains the highest possible obsolescence costs and/or highest possible demands for payment from the ascertained highest possible order quantities.

Quite particularly preferably, the first computer means compares on a period-related basis.

Preferably, the first computer means uses a connected display apparatus to output an error message and/or a warning if the actually accrued obsolescence costs and/or demands for payment are greater than the highest possible order quantities and/or highest possible obsolescence costs and/or highest possible demands for payment ascertained in the course of the production planning ascertainment.

Preferably, the computer means takes the ascertained, obsolescence costs and/or demands for payment as a basis for changing the production planning for the production installation connected to the computer means and/or for the production installation connected to the second computer means.

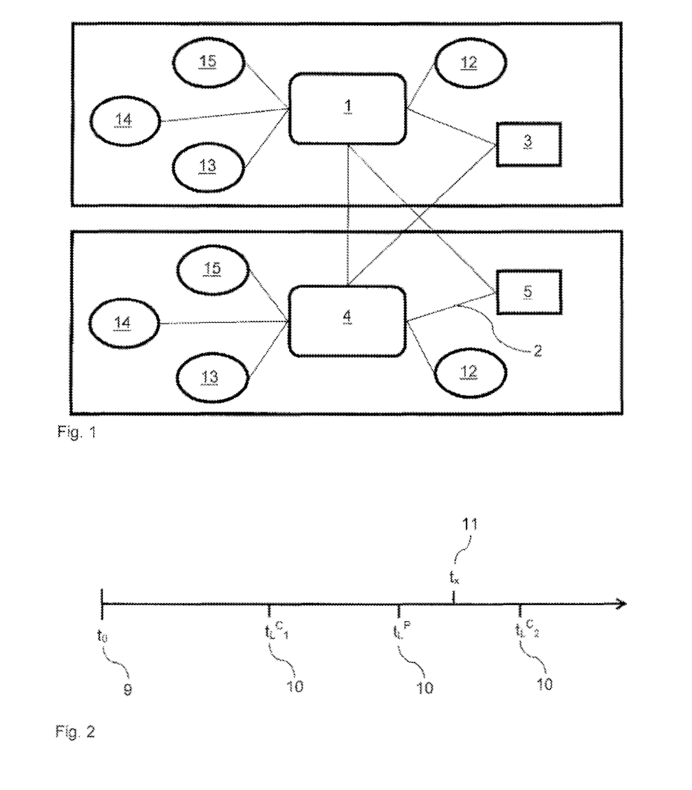

The inventions are explained below with reference to FIGS. 1-5. These explanations are merely by way of example and do not restrict the general inventive concept. The explanations apply to all subjects of the present invention in equal measures.

FIG. 1 shows a block diagram of a possible embodiment of the system.

FIG. 2 shows an exemplary, schematic illustration of the various relevant times in the method.

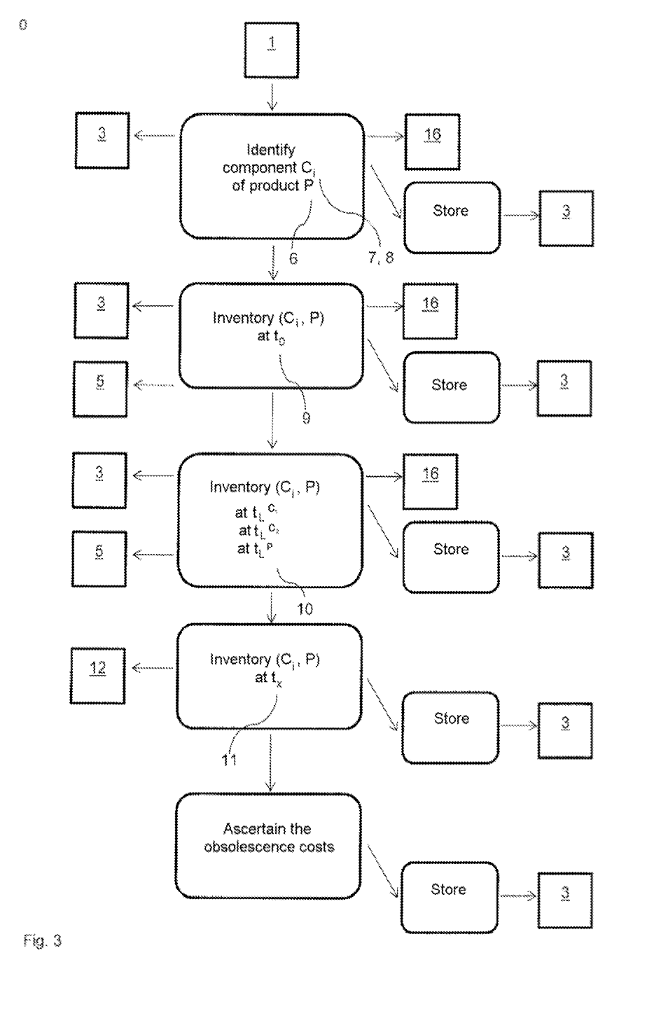

FIG. 3 snows a possible form of the method in the form of a flowchart.

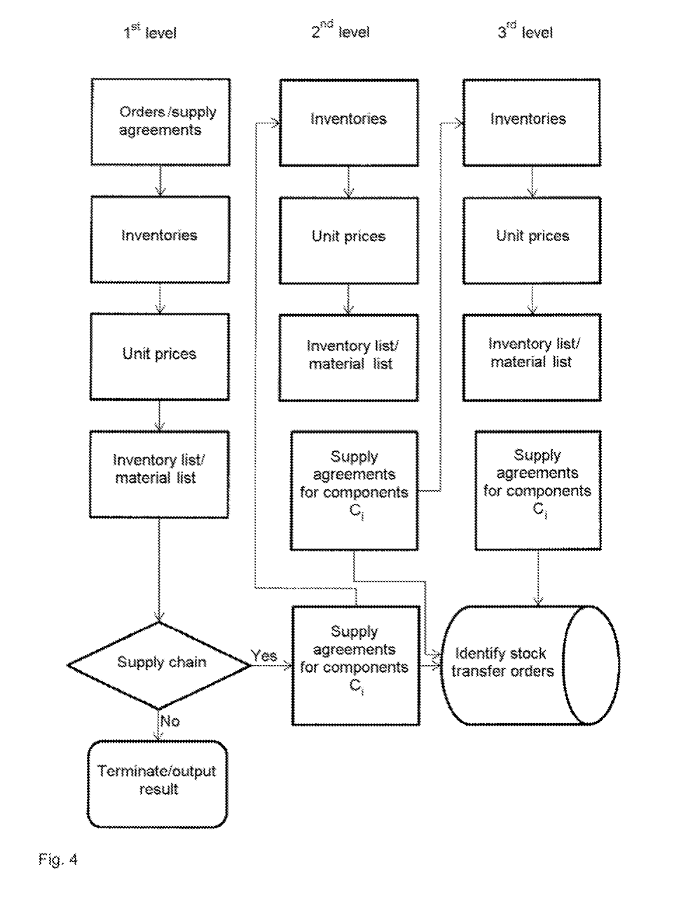

FIG. 4 shows an exemplary embodiment of the method.

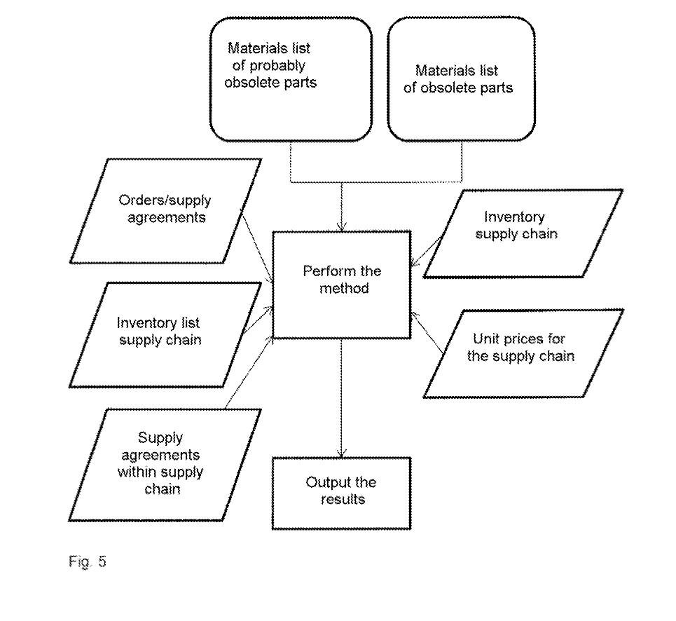

FIG. 5 shows a schematic overview of the method and. the inflowing parameters for a supply chain.

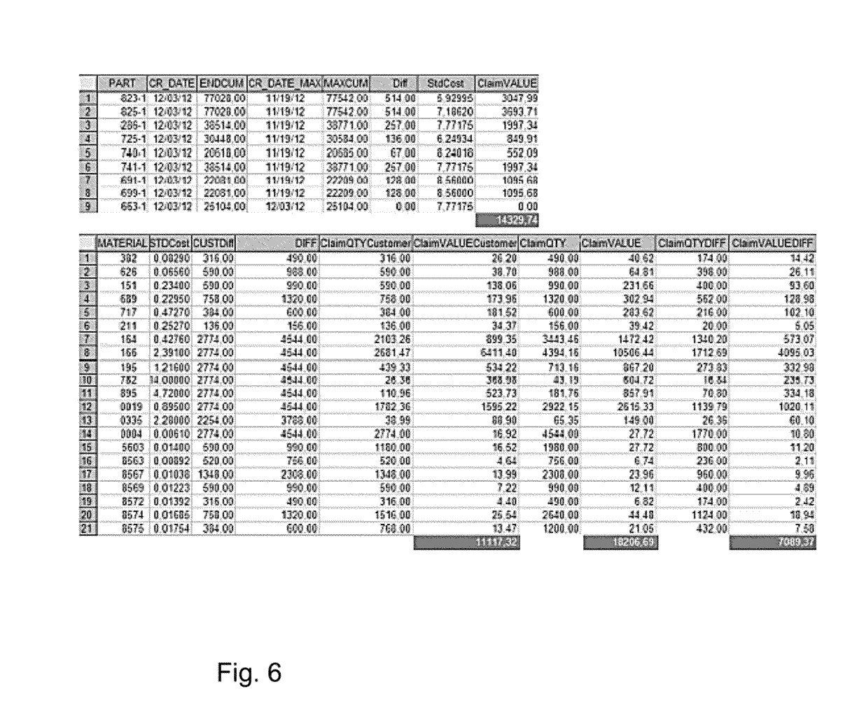

FIG. 6 shows a further embodiment of the method according to the invention.

A detailed description of the invention in the form of possible embodiments is provided below with reference to the drawings.

FIG. 1 shows two systems, as communicate with one another in the method. These may be the IT systems of the production installations of the product and/or component manufacturers, for example. Preferably, more than two systems communicate with one another. Each system consists of a centrally depicted first or second computer means 1, 4. and, in each case, a database 3, 5 connected to the computer means 1, 4. The first or second computer means 1, 4 are each connected to all components of the system by means of data connections 2.

The first and/or second computer means 1, 4 also has/have, apart from the database 3, 5, optionally the controller of a production unit 13 and/or the depot manager thereof, an input means 14 and/or a display apparatus 15 connected to it/them. If required, further system, components 12 can be connected to the computer means.

The systems are networked to one another via the computer means 1, 4. Preferably, the computer means 1, 4 are each directly connected to the databases 3, 5 of the respective other system.

FIG. 2 uses a timeline to show the times that are relevant to the method by way of example. The time at which the method is carried out or started is denoted by t₀ 9, Over the course of the method, the computer means 1 ascertains, if necessary, all components required for a product and the production planning for the product 6 and the components 7, 8 thereof. Usually, different supply agreements and. hence different supply and/or provisioning deadlines are available for the product and for the components, These are each indicated by t_{L}¹ 10. The key date for the production suspension or stoppage for a product and/or the components thereof is denoted by tₓ 11.

Preferably, the method is also used for more than one product and/or more than two components simultaneously.

FIG. 3 schematically outlines the course of such a method according to a preferred embodiment. The computer means 1 first of all identifies all components 7, 8 of the product 6. To this end, the computer means 1 accesses the database 3 and/or the inventory list 16, the inventory list 16 being able to be in any database, which may be at any location, that is connected to the computer means 1, that is to say particularly also in the database 3.

In the next step, the computer means 1 ascertains the inventory of the product 6 and the components 7, 8 thereof at the time t₀ 9. To this end, the computer means 1 accesses all those databases whose production installations or production units produce the product 6 and/or one or more of the components 7, 8 thereof. Preferably, the computer means 1 stores the ascertained, data, particularly preferably in the database 3.

Next, the computer means 1 ascertains the inventory of the product 6 and the components 7, 8 thereof at the time t_{L} 10. The procedure for this is precisely as described in the previous step. The products and/or components that are produced in addition to the current inventory at the time t_{L} 10 are taken into account for this. Preferably, the computer means 1 stores the ascertained data, particularly preferably in the database 3.

In the subsequent method step, the computer means 1 compares the ascertained or future inventories of the product 6 and the components 7, 8 thereof, based on the key date tₓ 11.

Again, the computer means 1 preferably stores the ascertained data, particularly preferably in the database 3. The computer means 1 preferably reads the key date tₓ 11 for the order and/or for the production migration or suspension from the connected database 3 and/or from another connected system component 13. Particularly preferably, the key date is supplied by an input means 14.

Finally, the computer means 1 ascertains the obsolescence costs and/or an estimation of obsolescence risk and/or demands for payment (obsolescence claims) using the data obtained. Particularly preferably, the computer means 1 stores the ascertained data, quite particularly preferably in the database 3.

According to one advantageous embodiment, the computer means 1 ascertains the key date tₓ 11 with the minimum obsolescence costs and, particularly preferably, the computer means 1 forwards the key date ascertained, in this manner to the other connected computer means. Quite particularly preferably, the computer means 1 stores the ascertained key date, particularly in the database 3.

According to a further advantageous embodiment of the method according ho the invention, the computer means 1 ascertains the actual or expected obsolescence costs and/or demands for payment on the basis of an altered, in particular lower, quantity for the order.

It is also conceivable for further parameters to have some influence on the optimization, for example weighting factors that, by way of example, allow for the fact, that it may be desirable to begin a new product cycle in order to obtain new customers and/or in order to put a new product onto the market, before competitors.

FIG. 4 shows an exemplary embodiment of the method as carried out by a computer means. The computer means 1 first of all checks whether the required parameters are available, for example in the database 3. By way of example, the required parameters comprise a key date tₓ, for which the expected and/or actual obsolescence costs are meant to be ascertained, and/or an obsolete product 6, particularly an identification that can be detected in the inventory list and/or materials list 16, and/or a statement about which production installations need to be involved in the method.

Preferably, the whole supply chain, particularly the production installations on all levels of the supply chain, is involved. Particularly preferably, the method is performed only for the production installation that is associated with the executing computing means 1.

For clarification purposes, an exemplary supply chain with three levels is shown in this case. It is clear to a person skilled in the art that the method can also be performed for more or fewer levels.

According to the embodiment shown, the computer means 1 ascertains, progressively and initially just for the first level of the supply chain, the existent supply agreements or orders from the customer or the purchaser, particularly the original equipment manufacturer, of the product 6 and/or the components 7, 8 thereof, particularly up to the key date tₓ, the inventories on the first level and the unit costs and/or unit prices.

In addition, the computer means 1 searches the

inventory list and/or materials list 16 and identifies the parts in question, that is to say particularly the product 6 and the components 7, 8 thereof.

The computer means 1 then checks whether or not the method needs to be performed for the whole supply chain. If not, the computer means 1 terminates the method and outputs at least one result, for example. If so, however, the computer means 1 iterates the method for at least one production installation on the next level of the supply chain. In so doing, it also ascertains the supply agreements for the components 7, 8 with other production installations on the same and/or another level, for example, and repeats the method for all levels until all production installations producing, processing and/or supplying the product 6 and/or the components 7, 8 thereof have been covered, and in particular the computer means 1 also identifies stock transfer orders and outputs at least one result.

FIG. 5 shows a schematic overview of the method and the influent parameters of a supply chain. The method distinguishes between actually accruing obsolescence costs for obsolete parts, that is to say products 6 and/or components 7, 8 that appear in a materials list, and forecast obsolescence costs, i.e. an obsolescence risk, for the obsolete parts.

The method is influenced by parameters from at least one production installation on at least one level of a supply chain. By way of example, the production planning is thus ascertained on the basis of orders or supply agreements at times t_{L}.

The computer means particularly also ascertains the supply agreements within the supply chain.

The computer means identifies the product 6 and/or the components 7, 8 thereof in the inventory list 16 of the supply chain.

In addition, the computer means ascertains the inventories of the product 6 and/or the components 7, 8 thereof in the supply chain, for example.

Furthermore, the computer means ascertains particularly the unit prices or costs of the product 6 and/or the components 7r 8 thereof in the supply chain.

At least some of these data are used by the computer means to perform the method according to the invention,

Once the computer means has carried out the method, preferably successfully, it outputs the results, for example via a display apparatus and/or in a data memory and/or by means of a further system component.

Optionally, the computer means ascertains cost-optimized production parameters therefrom for at least one production installation and transmits said production parameters to the production unit of the production installation.

The method according to the invention can be started either by the product manufacturer or by the component manufacturer, and said manufacturers can therefore plan their production better and without delay and/or coordinate it among one another, particularly in respect of pending product migrations and/or breaks in production. This firstly avoids significant costs as a result of superfluous material.

Secondly, it also avoids long lead times and/or delays in production, which in turn leads to greater customer satisfaction and also directly and/or indirectly to higher returns.

In addition, it is possible to clearly convey to a customer what probable and/or actual demands for payment would lie ahead of it if it subsequently amended its order. This would also render possible discussions within the supply chain obsolete, since the information can be viewed transparently by anybody and hence there are clear responsibilities.

The method can also advantageously be performed for key dates tₓ both in the past and in the future, and hence both forecasts and evaluations can be made.

Furthermore, this improves the basis for negotiation by manufacturers with the customer for a possible order following production migration that was associated with obsolescence costs.

Also, the overview of the stockkeeping for the whole supply chain increases social control, since every part of the supply chain now has all the necessary information to optimize its own stockkeeping, as a result of which it is no longer possible for responsibilities to be shifted on.

In addition, the method according to the invention advantageously allows both the actual or expected remaining quantities of the product and/or of the components to be ascertained and/or the costs associated with the remaining quantities.

It is also advantageously possible for claims that have actually been made to be compared with maximum claims ascertained in the course of the production planning and hence to identify and rule out unauthorized demands for payment.

Finally, the method according to the invention advantageously allows the production of a production installation to be adjusted and, in particular, optimized. This allows storage spaces to be decreased and hence the costs of the production installation to be lowered.

FIG. 6 shows a further embodiment of the method according to the invention. Two tables containing experimentally ascertained values for the. performance of the method according to the invention are shown. The computer means 1 ascertains the obsolescence risks, which correspond to possible demands for payment, for a key date tₓ that lies in the future as seen from the time at which the method to is carried out.

The method according to the invention can be performed equally well for a key date tₓ that is in the past or that coincides with the time at which, the method t₀ is carried out.

In this regard, on the basis of the example shown here, the computer means first of all ascertains a time t_{L} at which the production planning is ascertained. In this case, the computer means 1 compares this time t_{L} with prescribed periods in which the individual production units or installations can still react to changes in the production planning, for example new and/or amended orders. These periods may differ for different companies in a supply chain. By way of example, it is thus possible for a production unit 13, that is to say a company on a first level, to which the data in the upper table relate, to have a reaction period of 20 days, while a production unit 13 on a second level of a supply chain, the data of which are shown in the lower table, has a reaction period of 40 days. These figures are purely exemplary and may therefore also correspond to longer or shorter periods. It is likewise conceivable for a plurality of production units 13 on the same or a different level of a supply chain, to have the same and/or different periods.

The computer means 1 compares these reaction periods with the time of the production planning t_{L}. If this time comes after the time that results from the comparison between the time at which the method is carried out and the reaction period, then said, resultant time is relevant to the subsequent steps of the method. If it comes before the time that results from the reaction period, on the other hand, then the computer means 1 carries out all subsequent, steps of the method on the basis of the time of the production planning t_{L}.

The computer means 1 then ascertains all components 7, 8 of the product in the inventory list 16 available in one or more databases 3, 5 of the supply chain. These are indicated by their identification codes in the first column of the two tables.

Next, the computer means 1 ascertains the production planning from the data available in the databases 3, 5, In this case, the computer means 1 ascertains the maximum order quantity that can be expected, that is to say the maximum requirement or the maximum demand that can be expected, for the components 7, 8 (column 5 in the first table, MAXCUM) from the available orders, that is to say particularly past and present. Similarly, the computer means I ascertains the number of components 7, 8 that can be expected on the key date tₓ from the inventories and production data that are available in the inventory list 16.

From the comparison of the quantity of components 7, 8 that can be expected and the maximum demand that can be expected, the computer means 1 ascertains the difference, which in this case is indicated in the sixth column of the first, upper table and corresponds to the obsolescence risk of the component 7, 8. Optionally, the computer means 1 additionally ascertains the resultant obsolescence costs, in this case presented in. the last column.

The cumulated obsolescence costs then correspond to the obsolescence costs of the product 6, and in this case are 14329.74. On a first level of a supply chain, these obsolescence costs correspond to the possible demands for payment from the supply chain to the customer or OEM, for example.

According to the embodiment shown here, the computer means 1 then ascertains the obsolescence costs for the production units 13 on a further level of the supply chain, that is to say for subcomponents of the components 7, 8, for example. The corresponding data are shown in the second table. In this case, the obsolescence costs that can foe expected for the second level of the exemplary supply chain are shown in the sixth column.

In this case, the computer means 1 additionally ascertains the obsolescence costs that are to be expected with due regard to the orders by the production units 13 on the first level of the supply chain. These are shown in the eighth column of the lower table. If the orders from the first level, of the supply chain do not correspond to the orders from the customer or OEM, a differential amount is obtained, in this case 7089.37, that the computer means 1 ascertains by means of comparison. By way of example, these obsolescence costs arise as a result of the production units 13 on the first level of the supply chain ordering more from their suppliers on the basis of the orders from the customer, in accordance with the supply agreements with the customer, in order to be able to build a safety buffer.

Therefore, the obsolescence costs in the last column of the lower table cannot be bandied as authorised demands for payment to the customer, for example.

The method according to the invention thus ensures that both the customer or OEM and the production units of the supply chain are informed about possible obsolescence risks in good time and the production planning, that is to say the supply agreements and/or the production, can foe adjusted on the basis thereof.

If the method is performed again on or after the key date tₓ, the computer means 1 optionally compares the obsolescence costs that have actually arisen with the obsolescence costs to be expected that were ascertained previously.

### LIST OF REFERENCE SYMBOLS

1 First computer means
2 Data connection
3 Database
4 Second computer means
5 Database
6 Product
7 Component 1
8 Component 2
9 Time t₀ (time at which the method is carried out)
10 Time t₀ (time in production planning)
11 Time tₓ (hey date)
12 Other system component
13 Production unit
14 Input means
15 Display apparatus
16 Inventory list

1. A method for stock-keeping and/or estimation of obsolescence risk for at least one product, wherein the product is manufactured from at least two components, comprising:
the provision of:
a first computer means that is connected to at least one first database by means of a data connection;
at least one second computer means that is connected to at least one second database by means of a data connection; wherein the second database is connected to the first computer means by means of a data connection and each second computer means is connected to the first database by means of a data connection, wherein the first and/or second databases have data about the current inventory of the product and/or the components thereof and production planning therefor,
and at least the following steps:
each first computer means identifies all components of the product and the associated databases;
each first computer means ascertains the current inventory at a first time of the product and/or the components thereof;
each first computer means ascertains the production planning at a second time for the product and/or the components thereof;
each first computer means compares the current inventory at the first time and the production planning at the second time with the inventory on at least one key date at a third time for the product, which key date is present in or delivered by the database and/or another system component connected to the computer means;
each first computer means ascertains the obsolescence costs and/or demands for payment for the product and/or the components thereof.

2. The method as claimed in claim 1, wherein each first computer means and/or each second computer means is connected to an input means that is used to input at least one of the data required in the method.

3. The method as claimed in claim 1, wherein each first computer means and/or each second computer means is connected to a display apparatus that is used to display one or more of the data ascertained in the method.

4. The method as claimed in claim 1, additionally comprising the following steps:
ascertainment of the excess inventory at a current time by each first computer means by means of the data ascertained in the method; and
storage of the excess inventory at the current time in each first database and/or each second database by each first computer means.

5. The method as claimed in claim 1, wherein computation of the obsolescence costs and/or demands for payment involves use of current costs of the product and/or the components thereof or costs to be expected on the key date.

6. The method as claimed in claim 1, wherein computation of the obsolescence costs and/or demands for payment involves the use of costs of the product and/or the components thereof that are specific to each production installation.

7. The method as claimed in claim 1, wherein each first computer means ascertains an optimum time for production stoppage and/or a break in production by minimizing the obsolescence costs to be expected for a whole supply chain and/or portions of the supply chain over the course of time.

8. The method as claimed in claim 1, wherein some or all of the data transmission is effected in encrypted form.

9. The method as claimed in claim 1, wherein each first computer means and/or each second computer means is connected to a display apparatus and, in the event of an error in the course of the method, transmits an error message to the display apparatus.

10. The method as claimed in claim 1, wherein any access by each first computer means each second database is preceded by additional method steps as follows:
each first computer means checks whether there is access authorization between the first computer means and the second computer means and/or the second database.

11. The method as claimed in claim 1, additionally comprising the following method steps:
each first computer means stores at least one of the data and/or states ascertained during the method in each first database and/or in each second database.

12. The method as claimed in claim 1, wherein the first computer means ascertains the production planning on a period-related basis.

13. The method as claimed in claim 1, wherein the first computer means compares actually accrued obsolescence costs and/or demands for payment with the production planning, particularly with highest possible order quantities and/or highest possible obsolescence costs and/or highest possible demands for payment.

14. The method as claimed in claim 1, where in the first computer means uses a connected display apparatus to output an error message and/or a warning if the actually accrued obsolescence costs and/or demands for payment are greater than the highest possible order quantities and/or highest possible obsolescence costs and/or highest possible demands for payment ascertained in the course of the production planning ascertainment.

15. The method as claimed in claim 1, wherein in a further step the first computer means takes the ascertained obsolescence costs and/or demands for payment as a basis for adjusting the production planning for the production installation connected to the computer means.

16. The method as claimed in claim 1, wherein the first computer means ascertains highest possible obsolescence costs and/or highest possible demands for payment from the ascertained highest possible order quantities.
